(19) United States
(12) Patent Application Publication
(10) Pub. No.: US 2015/0003194 A1
(43) Pub. Date: Jan. 1, 2015

(54) DIRECTIONAL SELF-BURYING SENSOR SYSTEM AND METHOD

(71) Applicant: CGG SERVICES SA, Massy Cedex (FR)

(72) Inventor: Thierry BRIZARD, Massy Cedex (FR)

(73) Assignee: CGG SERVICES SA, Massy Cedex (FR)

(21) Appl. No.: 14/243,929

(22) Filed: Apr. 3, 2014

Related U.S. Application Data
(60) Provisional application No. 61/839,541, filed on Jun. 26, 2013.

(51) Int. Cl. G01V 1/16; E02F 1/00

(52) U.S. Cl. CPC G01V 1/162; E02F 1/00; G01V 1/38
USPC 367/15; 172/1

(57) ABSTRACT

Node, system and method for collecting seismic data. A node for collecting seismic data includes a base configured to land on the ocean floor; and a head connected to the base through a connecting member and configured to bury itself into the ocean floor. The head includes a seismic sensor configured to detect seismic data and first to third burying units configured to bury the head.

### BACKGROUND

1. Technical Field

Embodiments of the subject matter disclosed herein generally relate to methods and systems and, more particularly, to mechanisms and techniques for performing marine seismic monitoring using a node system with a directional self-burrowing seismic sensor.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of the geophysical structures under the seafloor is an ongoing process.

Marine reflection seismology is based on using a controlled source of energy that sends acoustic energy into the earth. By measuring the time it takes for the reflections to come back to plural receivers, it is possible to evaluate the depth and characterize features causing such reflections. These features may be associated with subterranean hydrocarbon deposits.

When used on water, this method may employ one or more vessels that tow streamers and seismic sources. The seismic sources are shot at predetermined times to generate seismic waves. The seismic waves propagate downward toward the seafloor and penetrate the seafloor until eventually a reflecting structure reflects the seismic waves. The reflected seismic waves then propagate upward until they are detected by various seismic receivers distributed on the streamers. Based on the data collected by the receivers, an image of the subsurface is generated by further analysis. Thus, an oil and/or gas reservoir may be discovered.

However, after the oil and/or gas reservoir has been discovered, it needs to be monitored to observe how the amount of oil and/or gas changes over time. For this goal, another method may be used to monitor the reservoir as illustrated in FIG. 1. Suppose that a reservoir 102 is buried under the seabed 104. A seismic monitoring system 100 may include ocean bottom nodes (OBNs, i.e., seismic sensors) 106 distributed across seabed 104 for monitoring reservoir 102 and connected to each other with cables 107 for transmitting recorded seismic data to a controller 108. A seismic source 110, e.g., towed by a vessel or located on an autonomous underwater vehicle (AUV), may generate the seismic waves while the OBNs 106 record the produced seismic data. Another AUV may travel to controller 108 and collect the recorded seismic data or the controller could be connected with a wire to shore or a floating data collector.

This traditional way of monitoring a reservoir has its own limitations. For example, the coupling between OBNs 106 and seabed 104 is not good, which results in high noise being recorded and, thus, a poor signal. Another disadvantage of the traditional method is the complicated nature of having OBNs connected to each other by cables and also to a global controller.

Accordingly, it would be desirable to provide systems and methods for recording seismic waves that provide good coupling with the seabed as well as easy deployment and maintenance.

### SUMMARY

According to one embodiment, there is a node for collecting seismic data. The node includes a base configured to land on the ocean floor; and a head connected to the base through a connecting member and configured to bury itself into the ocean floor. The head includes a seismic sensor configured to detect seismic data and first to third burying units configured to bury the head.

According to another embodiment, there is a node for collecting seismic data. The node includes a base configured to land on the ocean floor; and a head connected to the base through a connecting member and configured to bury itself into the ocean floor. The head includes a seismic sensor configured to detect seismic data and a burying mechanism configured to bury the head and to maintain its burying trajectory close to gravity.

According to yet another embodiment, there is a method for driving a seismic sensor into the ocean floor. The method includes landing a node on the ocean floor; deploying a head from the node to the ocean floor, wherein the head includes the seismic sensor; burying the head into the ocean floor using a burying mechanism; and correcting a burying trajectory of the head into the ocean floor based on spatial orientation measurements of the head acquired with an attitude unit.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional seismic monitoring system;

FIG. 2 is a schematic diagram of a seismic monitoring system having nodes with self-burying heads according to an embodiment;

FIG. 3 is a schematic diagram of a node having a self-burying head according to an exemplary embodiment;

FIG. 4 is a schematic diagram of a burying mechanism;

FIG. 5 is a schematic diagram illustrating the locations of burying units of the burying mechanism;

FIG. 6A is a schematic diagram of a burying unit;

FIG. 6B is a schematic diagram of a burying unit having an extending rod;

FIGS. 7A-D illustrate a burrowing head capable of correcting its trajectory with burying units;

FIGS. 8A-F illustrate how a burrowing head advances into the seafloor;

FIG. 9 is a schematic diagram of a system for monitoring a reservoir according to an embodiment;

FIG. 10 is a schematic diagram of another system for monitoring a reservoir according to an embodiment;

FIG. 11 is a flowchart of a method for collecting seismic data with a seismic system according to an embodiment; and

FIG. 12 is a schematic diagram of a controller.

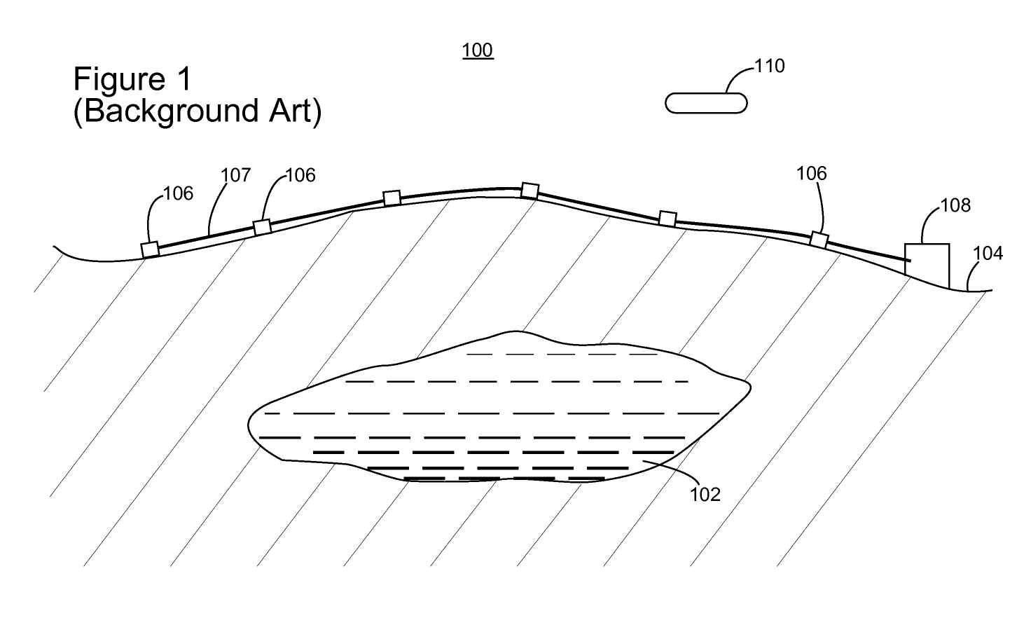

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of seismic nodes that are deployed by remotely operated vehicles (ROVs), exchange seismic data with autonomous underwater vehicles (AUVs) and have seismic sensors that burrow into the seabed. However, the embodiments to be discussed next are not limited to this combination of devices, but may be applied to other devices, e.g., gliders, vessels, cages, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Emerging technologies in marine seismic surveys need an inexpensive system for deploying and retrieving seismic receivers from the seabed. According to an exemplary embodiment, such a seismic system includes plural nodes having seismic receivers that can burrow into the seabed after the nodes have landed there. The nodes may be deployed/retrieved by ROVs. ROVs may also provide other functions, e.g., recharge/replace the nodes' batteries. The seismic sensors may be one of a hydrophone, geophone, accelerometer, or a combination of them. The AUV may be used to harvest from the nodes the seismic data and/or quality data. Further, the AUV may also be used to determine faulty nodes, recharge the nodes' batteries, control the operational mode, etc. Alternatively, the nodes are recovered by the ROVs and the data is transferred to the vessel when the nodes are on the vessel. Those skilled in the art would recognize other means for transferring the data from the nodes to the vessel or another desired location.

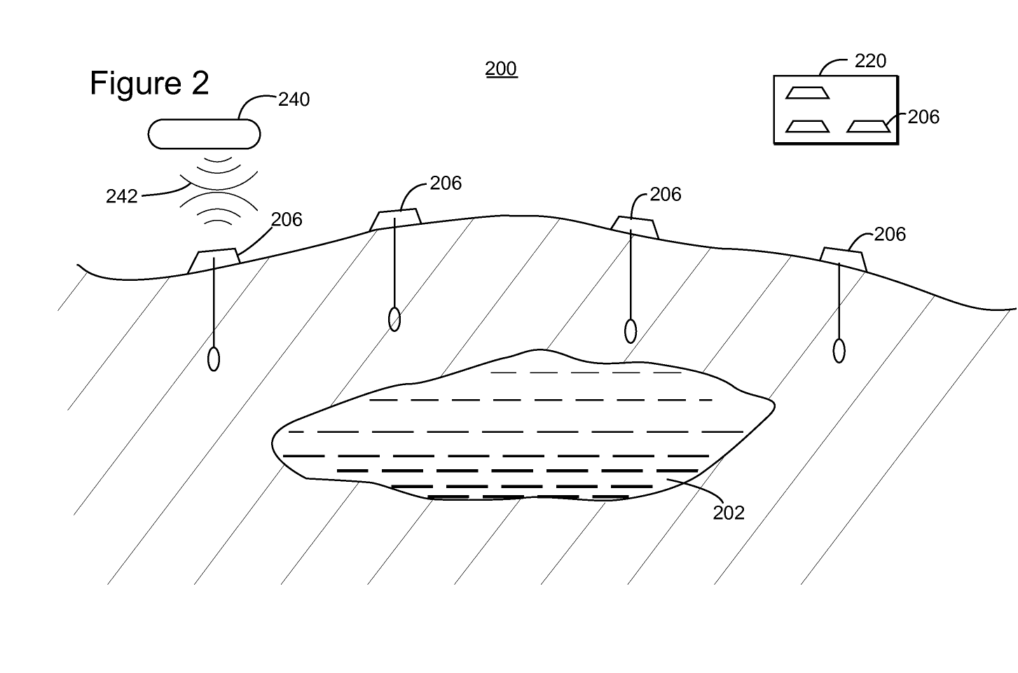

According to an embodiment illustrated in FIG. 2, a seismic monitoring system 200 includes plural nodes 206 distributed on the seabed 204 to monitor a reservoir 202. As illustrated in this figure, system 200 also includes at least one ROV 220 configured to deploy/recover nodes 206 while an AUV 240 communicates with the nodes for harvesting the data (both seismic and non-seismic). For example, both AUV 240 and nodes 206 may employ a wireless interface for exchanging electromagnetic signals 242 between the two. The structure of each element of the system is now discussed in more detail, after which the operation of the entire system is explained.

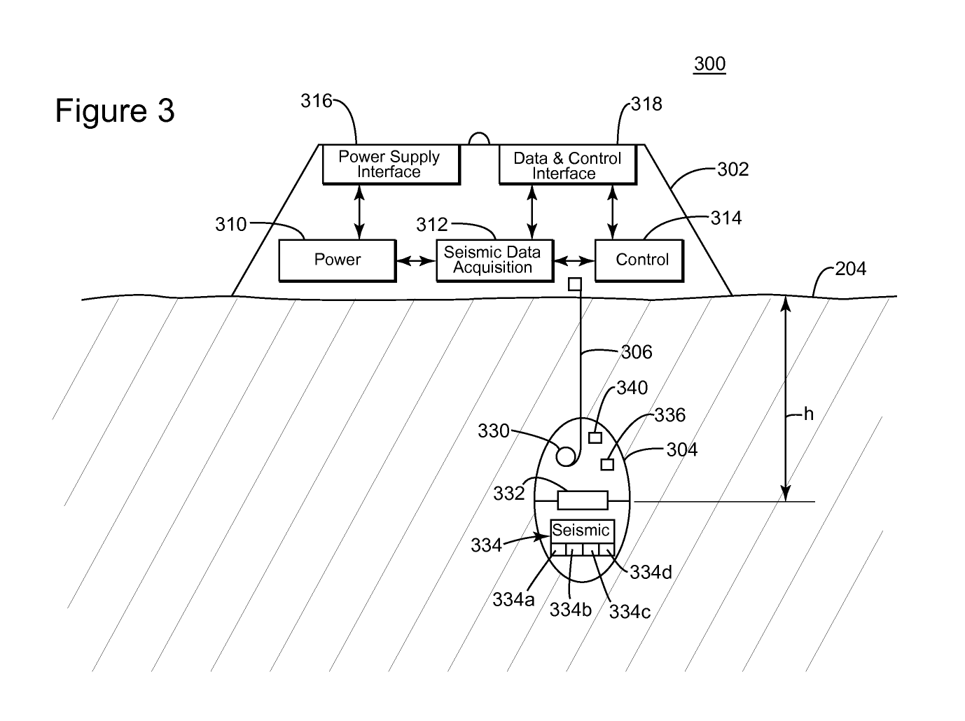

A node 300 (which corresponds to node 206 in FIG. 2) is illustrated in FIG. 3 and has a base portion 302 that, after deployment, is sitting on seabed 204 and also has a self-burying head 304 attached to the base 302 by a connector 306. Connector 306 may include at least one of a strength element, power cord, data communication wire, etc. In one application, self-burying head 304 can be fully retracted within base 302. However, in another application, part of head 304 may extend from base 302, although the head is stored inside the base. Base 302 may include a power supply unit 310, e.g., a battery, a fuel cell or other power sources, a seismic data acquisition unit 312 and a controller 314. These units are connected to each other. The seismic data acquisition unit 312 may include a processor and memory for storing seismic data recorded by the seismic sensor located in head 304. The processor and other electronics may be used, for example, to perform basic processing on the collected seismic data. Also, seismic data acquisition unit 312 may interact with the AUV and/or ROV through a data and control interface 318 to exchange various data. For example, the ROV and/or AUV may communicate with seismic data and acquisition unit 312 or controller 314 to transmit a start time for recording seismic data, a duration time for how long and how often to record seismic data, etc. Also, interface 318 may be used to send the recorded seismic data to the AUV and/or ROV, or to send quality control data, or to send status information, e.g., battery status or sensor status.

Base 302 also may include a power supply interface 316 for exchanging power with the ROV and/or AUV. In one application, when a low-battery status is detected by the AUV, either the AUV or the ROV may connect with a dedicated interface to interface 316 to recharge the node's power supply unit 310. In one application, either the AUV or the ROV may in fact replace power supply unit 310 with a new power supply unit.

Controller 314 also communicates with head 304. After base 302 has landed on seabed 204, controller 314 may instruct head 304 to burrow into the seabed. FIG. 3 illustrates head 304 buried to a depth h from seabed 204. Controller 314 may also instruct head 304 to stop burying itself when the desired depth h has been reached. In one embodiment, the desired depth h is about 20 m. Other values may be used, depending on the target of the survey, the consistency of the seabed, etc.

Still with regard to FIG. 3, head 304 may include a reel 330 on which connector 306 may be wound so that the distance between the head and the base is adjusted accordingly. The reel may be controlled by controller 314. Energy for actuating the reel may be provided by power supply unit 310. Head 304 may also include a burying system 332 for advancing the entire head toward the desired depth, a seismic unit 334, a fluidification mechanism 336 and an attitude unit 340. Seismic unit 334 may include one or more seismic sensors 334a (e.g., hydrophone, geophone, accelerometer, electro-magnetic sensor, or a combination thereof), a storage device 334b for storing the recorded seismic data, a processor 334c for processing the seismic data, and/or electronics for performing standard procedures, e.g., digitizing the data, etc. In one application, seismic unit 334 may also include a seismic source 334d for generating seismic waves. These seismic waves propagate toward the reservoir 202, and their reflections are recorded by seismic sensors 334a.

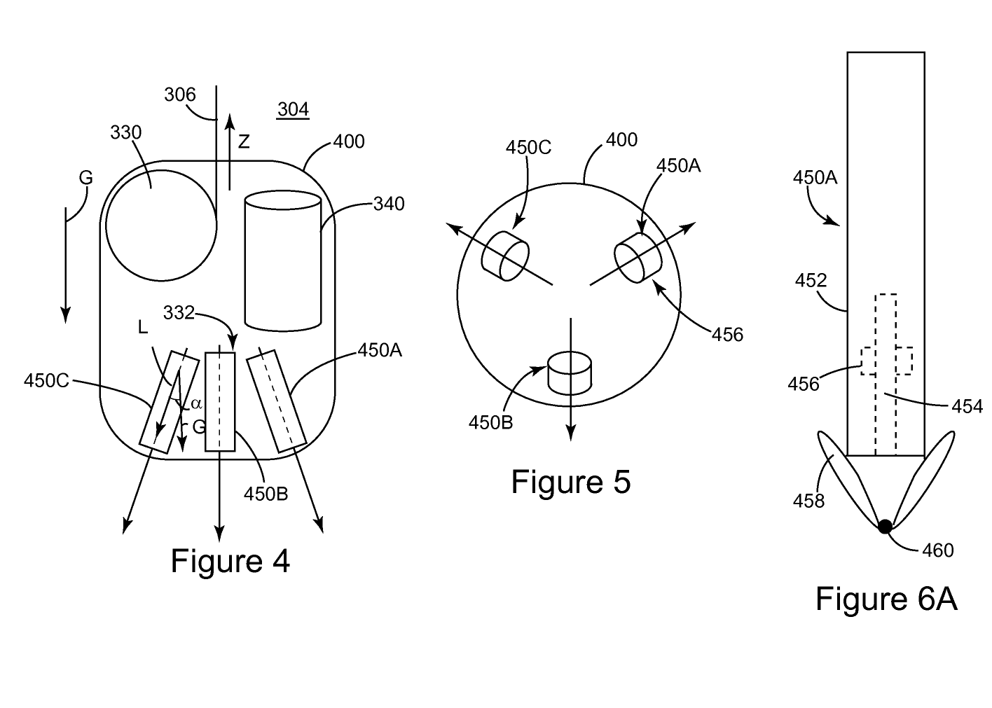

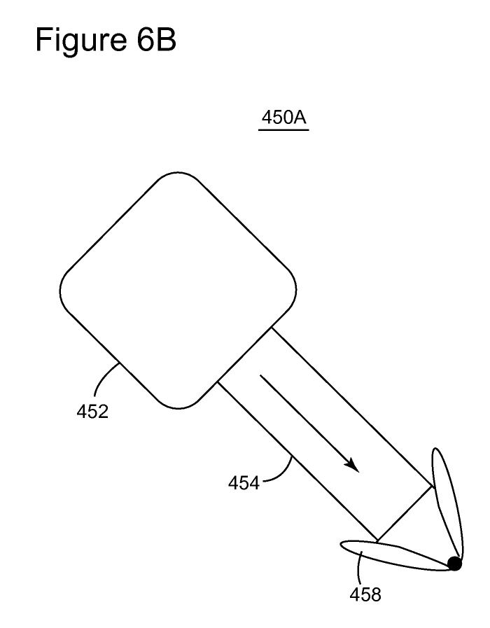

A burying system is illustrated in more detail in FIG. 4. Head 304 has a housing 400 and is configured to accommodate burying system 332, which has one or more burying units 450A-C. FIG. 4 shows three burying units for simplicity. If a configuration of three burying units is chosen, they may be symmetrically distributed (e.g., at substantially 120 degrees, one relative to another) with regard to a longitudinal axis Z of housing 400, as shown, for example, in FIG. 5. In one application, a longitudinal axis L of each burying unit 450A-C makes an angle α with gravity G. In one embodiment, angle α has a value of about 20 degrees. Other values may be used as will be appreciated by those skilled in the art. Housing 400 accommodates, partially or completely, each of the burying units 450A-C. Burying unit 450A is illustrated in FIG. 6A and has, in this embodiment, a body 452 and an extending rod 454. Inside body 452, an actuating device 456 (e.g., solenoid, pressurized tank, electrical motor or other appropriate mechanism) is providing the necessary force to extending rod 454 to extend it out of body 452 as illustrated in FIG. 6B. Burying unit 450A has one or more anchoring clamps 458 located at a distal end of the extending rod.

Each actuating device 456 is independently controlled by, for example, controller 314. A configuration of controller 314 is discussed later. Anchoring clamps (or barbes) 458 are rotatably attached to extending rod 454 for reasons to be discussed later. In other words, each anchoring clamp 458 may pivot (or rotate) relative to an attachment point 460, where the clamp is attached to the rod. Power for actuating the extending rod is supplied from base 302 of node system 300.

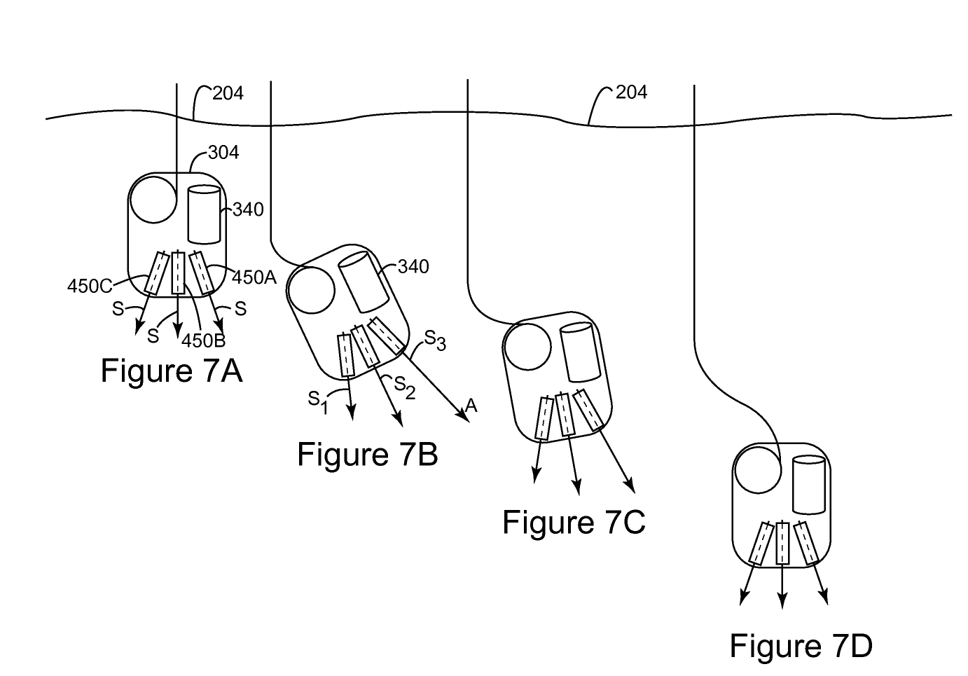

Head 304 also includes the attitude unit 340, which is attached to housing 400. Attitude unit 340 is configured to determine an actual spatial orientation of head 304 relative to gravity G. Thus, attitude unit 340 determines the pitch, roll and yaw of head 304. Such attitude unit 340 may include a three-dimensional accelerometer or three one-dimensional accelerometers for determining these parameters. The values of these parameters are transmitted to controller 314 for calculating the head's orientation relative to gravity. Based on the head's deviation from gravity, controller 314 calculates an actual extension for each extending rod of each burying unit 450A-C. In this way, it is possible to correct a head's trajectory while burrowing itself, as is now discussed with regard to FIGS. 7A-D.

FIG. 7A shows head 304 advancing beneath the seafloor 204, along the gravity direction. The three burying units 450A-C are simultaneously activated and each rod is extending with the same step S. However, head 304 deviates from gravity as shown in FIG. 7B. Attitude unit 340, which continuously feeds orientation data to controller 314, measures this deviation, and the controller evaluates the deviation. Controller 314 calculates new steps S1-S3 for each rod so that the trajectory of head 304 is corrected as shown in FIG. 7C. Controller 314 recalculates the step Sᵢ of each extending rod as the head advances, until the trajectory of the head is again aligned with gravity as illustrated in FIG. 7D. At this point, each extending rod is again extended with a same step S. Attitude unit 340 may be configured to repeat its measurements at any desired time interval, for example, every few seconds. The time interval may be adjusted based on the composition of the ocean floor, the speed of the head, etc. Controller 314 also coordinates reel 330 to dispense enough connector 306 as head 304 advances along its path.

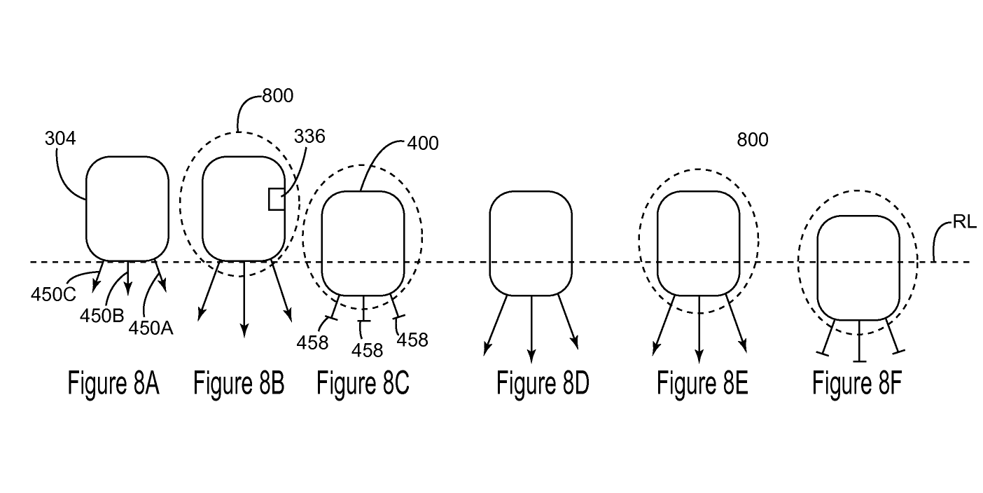

A process for advancing the head through the ocean floor is now discussed with regard to FIGS. 8A-F. FIG. 8A shows head 304 having burying units 450A-C un-extended and the housing bottom at a reference line RL. Next, controller 314 instructs the extending rod of each burying unit to extend according to a pre-calculated step Sᵢ, depending on the orientation of the head relative to gravity, as discussed above. The extended rods are illustrated in FIG. 8B. Next, the same controller instructs the fluidification mechanism 336 to fluidify a region 800 around housing 400. Fluidification mechanism 336 may include one of the following devices: a motor that rotates an asymmetrical weight to “shake” the housing, or a water pump that expels water through one or more outlets distributed around the housing, or another mechanism known in the art. Any of these mechanisms breaks the compact soil around the head and allows water to enter the loosened soil so that region 800 becomes easier for head 304 to penetrate. Note that if the ocean floor is soft enough, there is no need to fluidify region 800.

After region 800 has been fluidified, clamps 458 are extended to anchor burying units 450A-C, and then the extending rods are retracted inside the burying units, to force housing 400 to advance deeper into the ocean floor, as illustrated in FIG. 8C. Note that the bottom side of housing 400 is now past reference line RL. Then, as shown in FIG. 8D, the extending rods are extended back, the region around the housing is fluidified as illustrated in FIG. 8E, the clamps are extended and the rods are retracted as illustrated in FIG. 8F, and this process continues for a predetermined time or until a desired depth is achieved. During these phases, attitude unit 340 measures the head's spatial orientation and provides this information to the controller so that step Sᵢ of each extending rod is adjusted to maintain the vertical trajectory, as already discussed above with regard to FIGS. 7A-D. If the housing deviates from gravity, controller 314 adjusts each step for the extending rods to correct the head's spatial orientation.

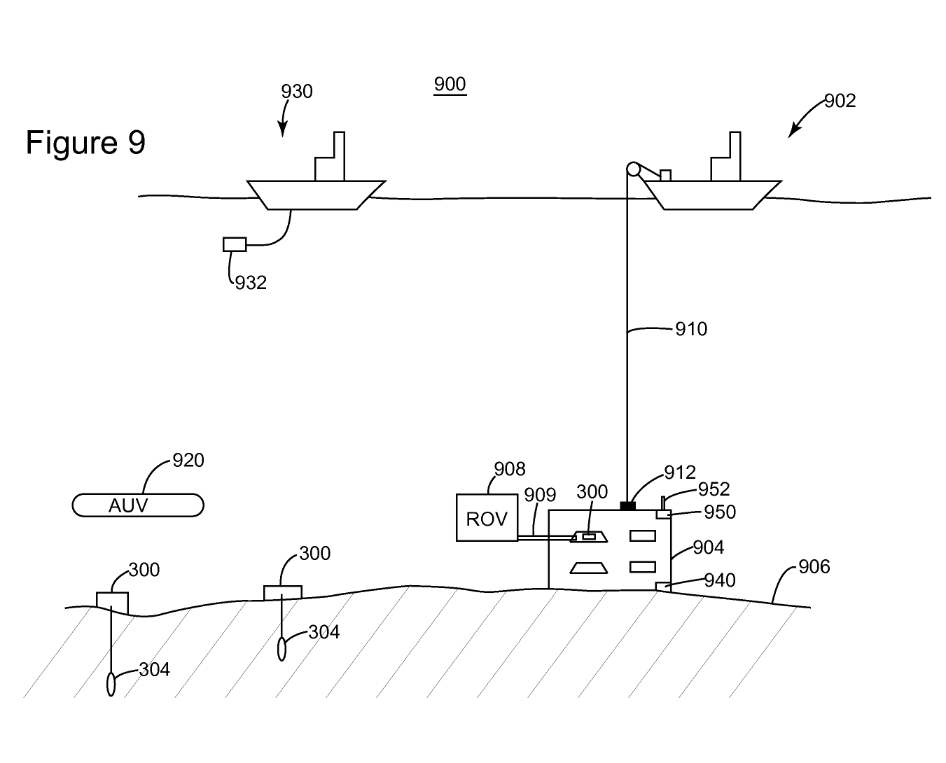

Various operational aspects of deploying, using and retrieving nodes 300 are now discussed with regard to FIG. 9. In this embodiment, a system 900 includes a vessel 902 that has deployed a cage 904 on seabed 906. Cage 904 stores plural nodes 300. Nodes 300 have been checked previously on board vessel 902 to ensure they have a fully-charged power supply unit, the seismic sensor(s) are working and all other components are operating normally. ROV 908 may be deployed by the same vessel 902 or a dedicated support vessel. ROV 908 is then guided to approach cage 904 and remove, one by one, nodes 300 for deploying them on seabed 906. In one application, cage 904 may still hang from a connecting mechanism 910 attached to vessel 902 while the ROV removes the nodes, i.e., cage 904 may not touch the seabed. However, for stability reasons, it is preferable to have cage 904 parked on the seabed. Although FIG. 9 shows the vessel's connecting device 910 still attached to the cage's connecting mechanism 912, this may not be the case after the cage is deployed on the seabed.

The ROV may deploy nodes 300 along a predetermined pattern, i.e., a regular grid. In one application, while ROV 908 deploys one node, the previously deployed node starts burrowing its head 304 as indicated in FIG. 9. While ROV 908 deploys the nodes, or after the ROV has finished deploying the nodes, AUV 920 is deployed, from the same vessel 902 or another vessel or platform. AUV 920 approaches deployed nodes 300 and starts to verify their positions, i.e., if they are on the predetermined grid. AUV 920 may also check the status of each node and their heads.

Once AUV 920 determines that the nodes are in place, operational and their heads have been buried to the desired depth, the nodes are ready to acquire and record seismic data. By having the seismic sensor embedded in the seabed (in the head), the coupling between the seismic sensor and the seabed is greatly improved, so high-quality seismic data may be acquired. In one application, different depths are used for plural nodes, i.e., one row of nodes may burrow their heads at a first depth, a second row of nodes may burrow their heads at a second depth, and so on. In one application, the heads of the nodes forming a row or column are buried to form a variable-depth profile. In one application, a source vessel 930 tows a seismic source 932 and shoots this source for producing seismic waves. In another application, source vessel 930 may be the same as vessel 902. In still another application, one or more nodes 300 have their own seismic source and they use these local seismic sources to generate seismic waves. In still another application, cage 904 is equipped with a seismic source 940, and this source is used for generating seismic waves.

During the seismic survey, nodes 300 may acquire not only seismic data but also non-seismic data, e.g., system position, environmental data (i.e., currents, temperature, salinity, speed of p-waves, speed of s-waves, etc.), geo-mechanical data, etc. The data may be recorded continuously or at predetermined times. In one application, the AUV may detect and record the non-seismic data noted above. After enough data is transferred from the nodes to the AUV, the AUV may surface and dock with its support vessel to transfer the data to the vessel. In an alternative embodiment, the AUV may approach cage 904 and transfer its data to a storage device 950 attached to the cage. The transfer may be wireless or wired through an appropriate interface 952. The seismic data may then be transferred from cage 904 to its support vessel 902 through connecting device 912. Thus, connecting device 912 may provide not only a strength member, but also a conduit for data transfer and a conduit for power transfer.

AUV 920 may also be in charge of monitoring nodes' performance. Thus, AUV 920 hovers above the nodes to make contactless connections with them and monitors whether the nodes are active and recording data, checks components' status, power units' status, data storage capacity, etc. In one application, AUV 920 may make direct contact with the nodes. During this phase, AUV 920 may determine that one or more nodes have a depleted power supply unit. In this case, a few scenarios are possible. According to a first scenario, the AUV itself may contact the node and transfer electric power to recharge the node's power supply. According to a second scenario, AUV 920 instructs ROV 908 or the operator of ROV 908 to recharge the power supply of a given node. For this situation, ROV 908 moves above the given node 300 and recharges its power supply unit. According to another scenario, ROV 908 may move next to the node and replace its depleted power unit with a charged power unit. ROV 908 may fetch, using a robotic arm 909, the charged power unit from cage 904 or directly from its support vessel.

When the seismic survey is concluded, the nodes are deactivated and prepared for retrieval. A signal indicative of the survey's end is either generated by the nodes' internal electronics, or sent by the AUV, ROV or one of the vessels. Upon receiving this signal, each node stops recording seismic data, pulls its head from the seabed (if the head is stuck, the node is configured to release support member 306 and leave the head behind), and powers down its components. ROV 908 starts picking up the nodes and returning them to their slots in cage 904. Once cage 904 is full, vessel 902 retrieves the cage and empties the nodes. Another cage or the same cage is sent again to continue the retrieval operation. Maintenance operations are then performed on each system component to prepare them for a new mission. Those skilled in the art would recognize that this is one possible way of retrieving the nodes. Other ways may be used, for example, making each node an AUV.

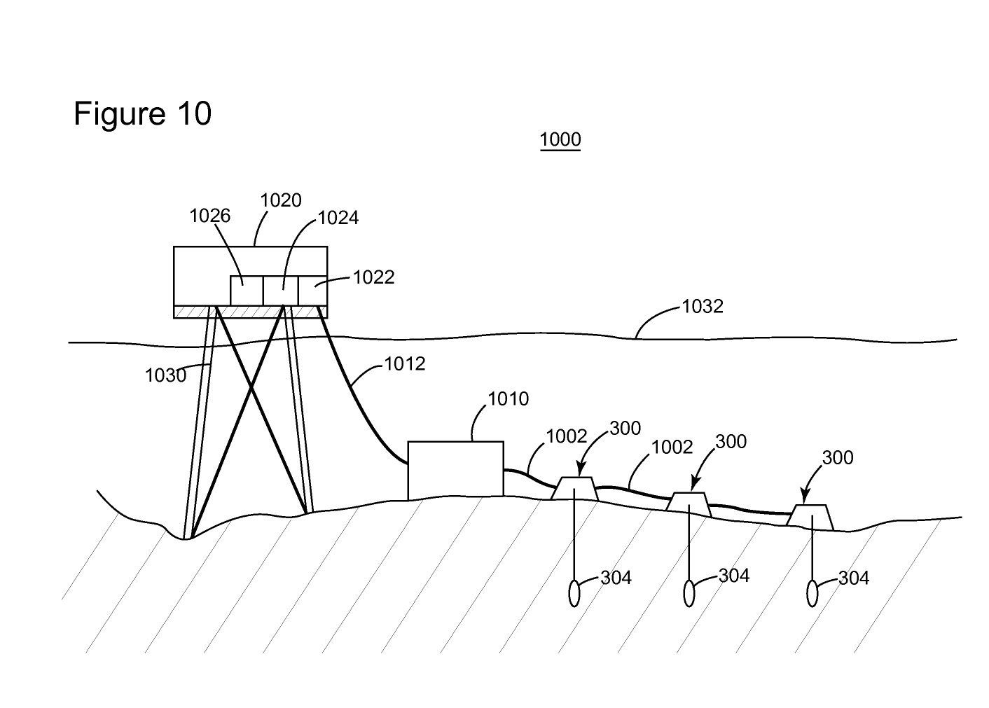

According to another embodiment illustrated in FIG. 10, a system 1000 includes the same nodes 300 having burrowing heads 304. However, this time, nodes 300 are connected to each other by cables 1002 connected to a subsea power and data terminal 1010. Subsea power and data terminal 1010 is connected in turn to a power and data source 1020 through a cable 1012. Cables 1002 and 1012 may transfer not only power but also data, i.e., they may include dedicated wires for electric power and dedicated wires (e.g., optical cable) for data communications. Power and data source 1020 may include a high-voltage power generator 1022, which may generate alternate current. Power and data source 1020 may be installed on a rig 1030, that is stationary above the seabed and/or water surface 1032. It may also include a large storage device 1024 for storing seismic and non-seismic data transmitted by nodes 300. Various processing means (e.g., processor) 1026 may also be present on rig 1030 for analyzing the recorded seismic data.

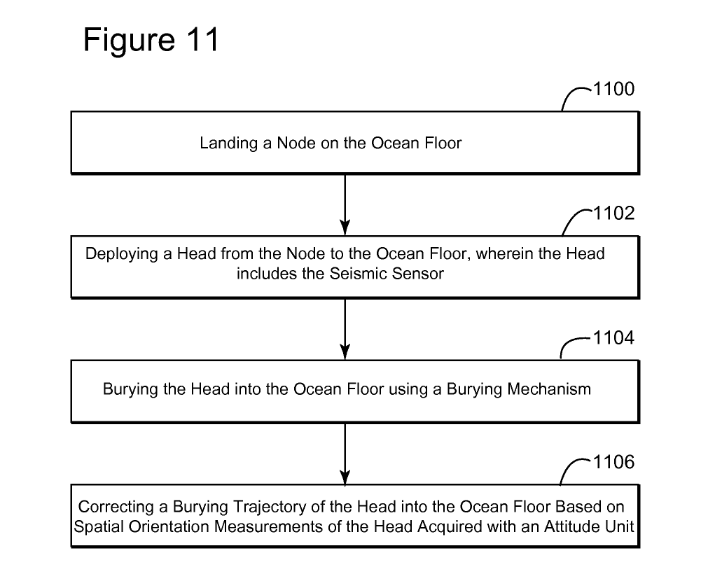

According to an embodiment illustrated in FIG. 11, there is a method for driving a seismic sensor into the ocean floor. The method includes a step 1100 of landing a node on the ocean floor; a step 1102 of deploying a head from the node to the ocean floor, wherein the head includes the seismic sensor; a step 1104 of burying the head into the ocean floor using a burying mechanism; and a step 1106 of correcting a burying trajectory of the head into the ocean floor based on spatial orientation measurements of the head acquired with an attitude unit.

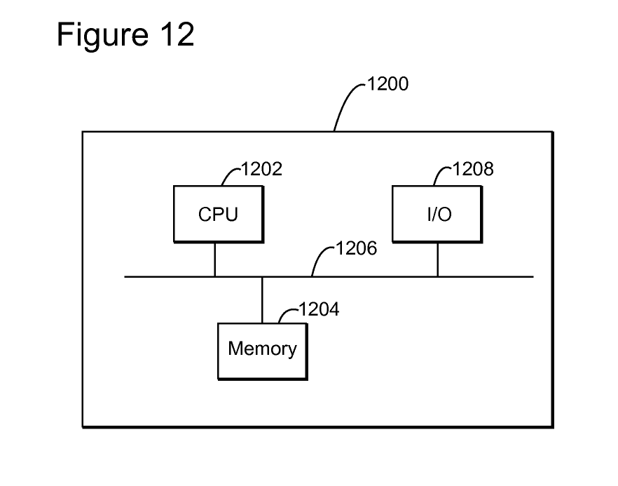

With regard to the various controllers discussed above, a possible configuration of such a device is schematically illustrated in FIG. 12. Such a controller 1200 includes a processor 1202 and a storage device 1204 that communicate with each other via a bus 1206. An input/output interface 1208 also communicates with the bus 1206 and allows an operator to communicate with the processor or the memory, for example, to input software instructions for operating the nodes, ROV, AUV, etc. The input/output interface 1208 may also be used by the controller to communicate with other controllers or interfaces provided on the various components of the system. For example, the input/output interface 1208 may communicate with a GPS system (not shown) for acquiring the actual position of the AUV at launch time, or with an acoustical system. The controller 1200 may be a computer, a server, a processor or dedicated circuitry.

One or more of the exemplary embodiments discussed above disclose a system and method for acquiring seismic data with nodes that have heads configured to bury into the seabed for better coupling with it. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A node for collecting seismic data, the node comprising:
a base configured to land on the ocean floor; and
a head connected to the base through a connecting member and configured to bury itself into the ocean floor,
wherein the head includes a seismic sensor configured to detect seismic data and first to third burying units configured to bury the head.

2. The node of claim 1, wherein the head further comprises:
an attitude unit configured to measure a spatial orientation of the head relative to gravity.

3. The node of claim 2, wherein the attitude unit is configured to measure pitch, roll and yaw of the head.

4. The node of claim 2, wherein a longitudinal axis of each burying unit makes an angle α with the gravity and the burying units are symmetrically distributed around a longitudinal axis of the head.

5. The node of claim 4, wherein the angle α is about 20°.

6. The node of claim 2, wherein the base includes a controller configured to receive data from the attitude unit and to control each of the burying unit.

7. The node of claim 6, wherein the controller calculates different extending steps Sᵢ for each burying unit when an orientation of the head diverges from gravity.

8. The node of claim 7, wherein each burying unit has an extending rod that extends away from the head with a corresponding step Sᵢ.

9. The node of claim 7, wherein each burying unit includes a solenoid for actuating a corresponding extending rod.

10. The node of claim 1, wherein the base comprises:
a power source for supplying power to the seismic sensor and the burying units.

11. The node of claim 1, wherein the head comprises:
a fluidification mechanism configured to loosen the soil around the head.

12. A node for collecting seismic data, the node comprising:
a base configured to land on the ocean floor; and
a head connected to the base through a connecting member and configured to bury itself into the ocean floor,
wherein the head includes a seismic sensor configured to detect seismic data and a burying mechanism configured to bury the head and to maintain its burying trajectory close to gravity.

13. The node of claim 12, wherein the head further comprises:
an attitude unit configured to measure a spatial orientation of the head relative to gravity.

14. The node of claim 12, wherein the burying mechanism includes three burying units, each burying unit making an angle α with the gravity.

15. The node of claim 14, wherein the base includes a controller configured to receive data from the attitude unit and to control each of the burying units.

16. The node of claim 15, wherein the controller calculates different extending steps Sᵢ for each burying unit when an orientation of the head diverges from gravity.

17. The node of claim 15, wherein each burying unit includes a solenoid for actuating a corresponding extending rod.

18. The node of claim 12, wherein the head comprises:
a fluidification mechanism configured to loosen the soil around the head.

19. A method for driving a seismic sensor into the ocean floor, the method comprising:
landing a node on the ocean floor;
deploying a head from the node to the ocean floor, wherein the head includes the seismic sensor;
burying the head into the ocean floor using a burying mechanism; and
correcting a burying trajectory of the head into the ocean floor based on spatial orientation measurements of the head acquired with an attitude unit.

20. The method of claim 19, further comprising:
calculating in a controller, based on the spatial orientation measurements, steps Sᵢ for corresponding extending rods of the burying mechanism; and
instructing the extending rods to extend into the ocean floor with the calculated steps Sᵢ.
